(19) United States
(12) Patent Application Publication
(10) Pub. No.: US 2023/0143884 A1
(43) Pub. Date: May 11, 2023

(54) SILICON-CARBON COMPOSITE MATERIAL WITH INTERNAL PORE STRUCTURE AND ITS PREPARATION METHOD AND APPLICATION

(71) Applicant: Guangdong Kaijin New Energy Technology Co., Ltd., Dongguan (CN)

(72) Inventors: Anhua ZHENG, Dongguan (CN); Dexin YU, Dongguan (CN); Rusheng FU, Dongguan (CN); Yunlin YANG, Dongguan (CN)

(73) Assignee: Guangdong Kaijin New Energy Technology Co., Ltd., Dongguan (CN)

(21) Appl. No.: 17/709,431

(22) Filed: Mar. 31, 2022

(30) Foreign Application Priority Data
Nov. 9, 2021 (CN) 202111322043.8

(51) Int. Cl. H01M 4/36; H01M 10/0525; H01M 4/38; H01M 4/587

(52) U.S. Cl. CPC H01M 4/366; H01M 10/0525; H01M 4/386; H01M 4/587; H01M 2004/021

(57) ABSTRACT

A long-cycle and low-expansion silicon-carbon composite material with an internal pore structure includes a silicon source, a closed pore, a filling layer and a carbon coating layer. The closed pore is a large closed pore or composed of a plurality of small closed pores and the filling layer is a carbon filling layer. The invention provides a long-cycle and low-expansion silicon-carbon composite material with an internal pore structure which is reduced in volume expansion effect and improved in volume effect of cycle performance. The invention further provides a preparation method and application of a long-cycle and low-expansion silicon-carbon composite material with an internal pore structure. The process is simple. The volume expansion effect being reduced and the cycle performance being improved are of great significance to the application of silicon-based materials in lithium-ion batteries.

### FIELD

The invention relates to the field of lithium-ion battery anode materials, and in particular to a long-cycle and low-expansion silicon-carbon composite material with an internal pore structure and its preparation method and application.

### BACKGROUND

At present, commercial anode materials are mainly graphite materials, but because of their low theoretical capacity (372 mAh/g), they cannot meet the demands of the market. In recent years, people's attention has been paid on new high-specific capacity anode materials: lithium storage metals and their oxides (such as Sn and Si) and lithium transition metal phosphides. Among the many new high-capacity anode materials, Si has become one of the highest potential alternative graphite materials due to its high theoretical specific capacity (4200 mAh/g), but the Si-based material is prone to cracking and pulverization due to its huge volume effect during charging and discharging, thereby losing contact with the current collector and resulting in a sharp drop in cycle performance. Therefore, reducing the volume expansion effect and improving the cycle performance are of great significance to the application of silicon-based materials in lithium-ion batteries.

The existing silicon-carbon anode material is made from a silicon source and graphite by compounding and granulating. As the silicon source is difficult to disperse uniformly, it will inevitably lead to the phenomenon of local agglomeration of the silicon source during the granulation process. The agglomeration of the silicon source will cause local stress concentrations during charging and discharging, leading to local structural damage of the composite material and affecting the overall performance of the material. Therefore, how to reduce the volume expansion effect and improve the cycle performance is of great significance to the application of silicon-based materials in lithium-ion batteries.

### SUMMARY

In order to solve the above technical problems, the invention provides a long-cycle and low-expansion silicon-carbon composite material with an internal pore structure that is reduced in volume expansion effect and improved in cycle performance.

The invention further provides a preparation method and application of a long-cycle and low-expansion silicon-carbon composite material with an internal pore structure. The process is simple. Reducing the volume expansion effect and improving the cycle performance are of great significance to the application of silicon-based materials in lithium-ion batteries.

The invention adopts the following technical solutions.

Provided is a long-cycle and low-expansion silicon-carbon composite material with an internal pore structure. The long-cycle and low-expansion silicon-carbon composite material with an internal pore structure comprises a silicon source, a closed pore, a filling layer and a carbon coating layer, wherein the closed pore is a large closed pore or composed of a plurality of small closed pores, the filling layer is a carbon filling layer filled among particles of the silicon source, and the carbon coating layer encloses the silicon source, the closed pore and the filling layer therein.

As a further improvement to the above technical solution, an outer surface of the closed pore includes a carbon layer and a size of the closed pore is 0.01 μm to 8 μm.

As a further improvement to the above technical solution, the silicon source is any one or more of polycrystalline nano-silicon and amorphous nano-silicon.

As a further improvement to the above technical solution, when the silicon source is polycrystalline nano-silicon, a crystal size of the polycrystalline nano-silicon is 1 nm to 40 nm.

As a further improvement to the above technical solution, the silicon source is SiOx, where X is between 0 and 0.8; a particle diameter D50 of the silicon source is less than 200 nm.

Further provided is a preparation method of a long-cycle and low-expansion silicon-carbon composite material with an internal pore structure, including the following steps:

S0, mixing and dispersing a silicon source, a dispersant, and a pore-former in a solvent evenly, and performing spray drying treatment to obtain a precursor A;

S1, carbonizing the precursor A to obtain a precursor B;

S2, mechanically mixing and fusing the precursor B and an organic carbon source to obtain a precursor C;

S3, carrying out high-temperature vacuum/pressurized carbonization on the precursor C to obtain a precursor D;

S4, crushing and sieving the precursor D to obtain a precursor E; and

S5, carrying out carbon coating heat treatment on the precursor E to obtain the silicon-carbon composite material.

As a further improvement to the above technical solution, the pore-former in step S0 is an organic substance insoluble or slightly soluble in the dispersant.

As a further improvement to the above technical solution, the pore-former includes one or more of sucrose, glucose, citric acid, phenolic resin, epoxy resin, polyimide resin, pitch, polyvinyl alcohol, polypyrrole, polypyrrolidone, polyaniline, polyacrylonitrile, polydopamine, polyethylene, polypropylene, polyamide, polystyrene, polymethyl methacrylate, and polyvinyl chloride.

As a further improvement to the above technical solution, in step S0, a ratio of the pore-former to the silicon source is 1% to 80%.

Further provided is an application of a long-cycle and low-expansion silicon-carbon composite material with an internal pore structure. The long-cycle and low-expansion silicon-carbon composite material with an internal pore structure prepared by the above preparation method is applied to lithium-ion batteries.

The beneficial effects of the present disclosure are as follows.

The invention provides a long-cycle and low-expansion silicon-carbon composite material with an internal pore structure. The filling layer forms a three-dimensional conductive network among silicon source particles. The three-dimensional conductive network can not only effectively improve the conductivity of silicon-based materials, but also effectively alleviate the volume effect during the charge and discharge process, thereby effectively avoiding the pulverization of the material during the cycle and further avoiding direct contact between the silicon source and electrolyte during the cycle to reduce side reactions. The closed pore in the silicon-carbon composite material can further absorb stress during the charge and discharge process, and further reduce the expansion of the material. The outermost carbon coating layer can avoid direct contact between the silicon source and the electrolyte to reduce side reactions and can further improve the conductivity of the silicon-based materials and alleviate the volume effect during charging and discharging.

### BRIEF DESCRIPTION OF THE DRAWINGS

FIG. 1 is a schematic structural diagram of a long-cycle and low-expansion silicon-carbon composite material with an internal pore structure according to the invention;

FIG. 2 is a cross-section view of a sample of Example 1 of the long-cycle and low-expansion silicon-carbon composite material with an internal pore structure according to the invention;

FIG. 3 is a cross-section view of a sample of Example 3 of the long-cycle and low-expansion silicon-carbon composite material with an internal pore structure according to the invention; and

FIG. 4 is a charge-discharge curve of the sample of Example 1 of the long-cycle and low-expansion silicon-carbon composite material with an internal pore structure according to the invention.

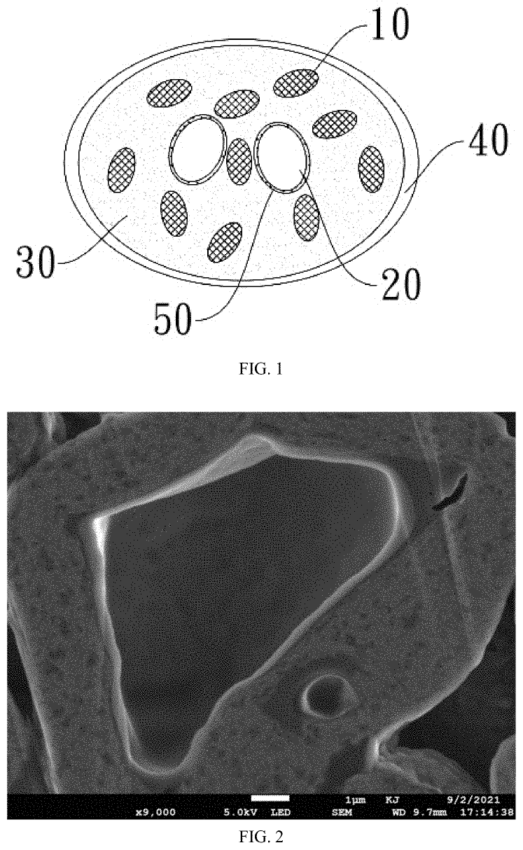

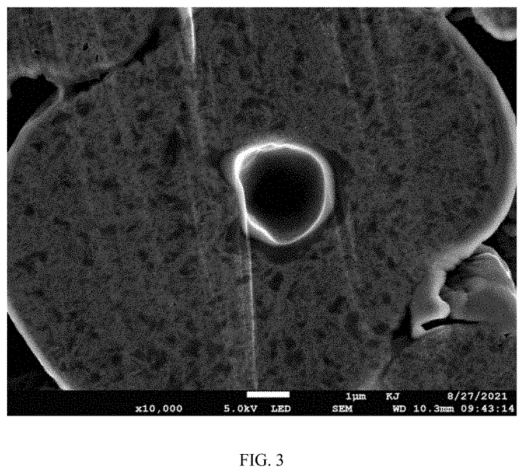

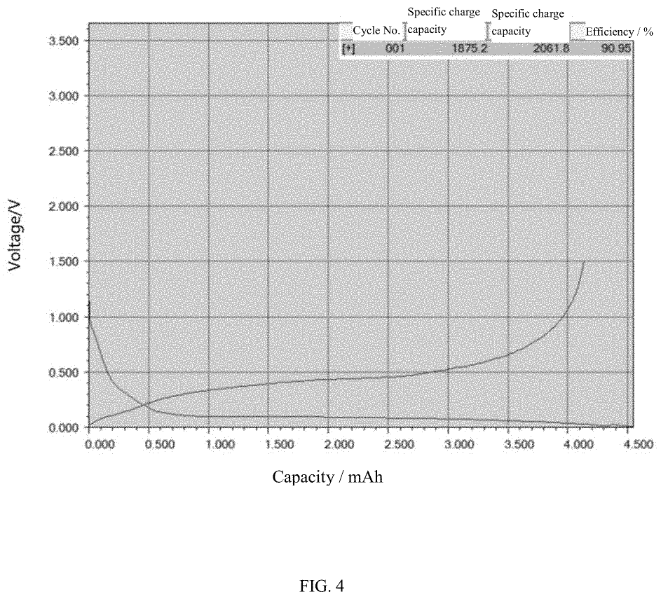

### DESCRIPTION OF THE EMBODIMENTS

For a better understanding, the present invention will be further described below in conjunction with the embodiments, but the embodiments of the present invention are not limited thereto.

A long-cycle and low-expansion silicon-carbon composite material with an internal pore structure, comprises a silicon source 10, a closed pore 20, a filling layer 30 and a carbon coating layer 40. The silicon source 10 is nano-Si particles or nano-SiOₓ particles, and its particle diameter D50 is less than 200 nm. The closed pore 20 may be a large closed pore 20, or composed of a plurality of small closed pores 20. An outer surface of the closed pore 20 is a carbon layer 50. The filling layer 30 is a carbon filling layer 30 filled among particles of the silicon source 10 to modify the surface of the particles with carbon, at least one surface modification layer is provided, and a thickness of the single surface modification layer is 0.05 μm to 1.0 μm. The carbon coating layer encloses the silicon source 10, the closed pore 20 and the filling layer 30 therein.

Preferably, a size of the closed pore 20 of the long-cycle and low-expansion silicon-carbon composite material with an internal pore structure is 0.01 μm to 8 μm, more preferably 0.1 μm to 7 μm, particularly preferably 0.1 μm to 5 μm; a size of the large closed pore is larger than 50 nm but less than or equal to 8 μm, and a size of the small closed pore is larger than 10 nm but less than or equal to 50 nm. In the present application, the size of the closed pore 20 means the length of a straight line segment extending through the center of the closed pore 20 and opposite ends of the straight line segment intersecting with the boundary of the closed pore 20.

preferably, a tap density of the long-cycle and low-expansion silicon-carbon composite material with an internal pore structure is 0.5 g/cc to 1.2 g/cc, more preferably 0.7 g/cc to 1.2 g/cc, particularly preferably 0.9 g/cc to 1.2 g/cc;

preferably, the silicon source 10 is SiOₓ, where X is between 0 and 0.8;

preferably, an oxygen content of the silicon source 10 is 0 to 20%, further preferably 0 to 15%, particularly preferably 0 to 10%;

preferably, the particle diameter D50 of the silicon source 10 is less than 200 nm, more preferably 30 nm to 150 nm, and particularly preferably 50 nm to 150 nm.

Preferably, the silicon source 10 is any one or more of polycrystalline nano silicon or amorphous nano silicon, and a crystal size of the polycrystalline nano silicon is 1 to 40 nm.

The long-cycle and low-expansion silicon-carbon composite material with an internal pore structure comprises a silicon source 10, a closed pore 20, and a filling layer 30.

Preferably, the particle diameter D50 of the long-cycle and low-expansion silicon-carbon composite material with an internal pore structure is 2 μm to 20 μm, more preferably 2 μm to 15 nm, particularly preferably 2 μm to 10 μm.

Preferably, the particle diameter Dmax of the long-cycle and low-expansion silicon-carbon composite material with an internal pore structure is 10 μm to 40 μm, more preferably 10 nm to 35 nm, and particularly preferably 10 μm to 30 μm.

Preferably, a specific surface area of the long-cycle and low-expansion silicon-carbon composite material with an internal pore structure is 0.5 m²/g to 10 m²/g, more preferably 0.5 m²/g to 5 m²/g, particularly preferably 0.5 m²/g to 2 m²/g.

Preferably, a porosity of the long-cycle and low-expansion silicon-carbon composite material with an internal pore structure is 1% to 15%, more preferably 1% to 10%, and particularly preferably 1% to 3%.

Preferably, an oxygen content of the long-cycle and low-expansion silicon-carbon composite material with an internal pore structure is 0 to 20%, more preferably 0 to 15%, particularly preferably 0 to 10%.

Preferably, a carbon content of the long-cycle and low-expansion silicon-carbon composite material with an internal pore structure is 20% to 90%, more preferably 20% to 75%, particularly preferably 20% to 60%.

Preferably, a silicon content of the long-cycle and low-expansion silicon-carbon composite material with an internal pore structure is 5% to 90%, more preferably 20% to 70%, particularly preferably 30% to 60%.

Further provided is a preparation method of the long-cycle and low-expansion silicon-carbon composite material with an internal pore structure, including the following steps:

S0, mixing and dispersing the silicon source 10, a dispersant, and a pore-former in a solvent evenly, and performing spray drying treatment to obtain a precursor A;

S1, carbonizing the precursor A to obtain a precursor B;

S2, mechanically mixing and fusing the precursor B and an organic carbon source to obtain a precursor C;

S3, carrying out high-temperature, vacuum or pressurized carbonization on the precursor C to obtain a precursor D;

S4, crushing and sieving the precursor D to obtain a precursor E; and

S5, coating the precursor E with carbon to obtain the long-cycle and low-expansion silicon-carbon composite material with an internal pore structure.

According to the preparation method of the long-cycle and low-expansion silicon-carbon composite material with an internal pore structure, the dispersant in step S0 is an organic solvent or water; the organic solvent is one or more of an oil solvent, an alcohol solvent, a ketone solvent, an alkane solvent, N-methylpyrrolidone, tetrahydrofuran, and toluene; the oil solvent is one or more of kerosene, a mineral oil, and a vegetable oil; the alcohol solvent is one or more of ethanol, methanol, ethylene glycol, isopropanol, n-octanol, propenol, and octanol; the ketone solvent is one or more of acetone, methyl methyl ethyl ketone, methyl isobutyl ketone, methyl ethyl ketone, methyl isoacetone, cyclohexanone, and methyl hexanone; the alkane solvent is one or more of cyclohexane, n-hexane, isoheptane, 3,3-dimethylpentane, and 3-methylhexane.

The pore-former in step S0 is an organic substance insoluble or slightly soluble in the dispersant and includes one or more of sucrose, glucose, citric acid, phenolic resin, epoxy resin, polyimide resin, pitch, polyvinyl alcohol, polypyrrole, polypyrrolidone, polyaniline, polyacrylonitrile, polydopamine, polyethylene, polypropylene, polyamide, polystyrene, polymethyl methacrylate, and polyvinyl chloride.

Preferably, the carbon content of the pore-former is 1% to 70%, more preferably 1% to 50%, particularly preferably 1% to 30%.

Preferably, a particle diameter D50 of the pore-former is 0.1 μm to 15 μm, more preferably 0.1 μm to 10 μm, particularly preferably 0.1 μm to 6 μm.

Preferably, a ratio of the pore-former to the silicon source 10 is 1% to 80%, more preferably 1% to 60%, particularly preferably 1% to 40%.

In the preparation method of the long-cycle and low-expansion silicon-carbon composite material with an internal pore structure, the carbonization treatment in step S1 is one or more of vacuum carbonization, dynamic carbonization, static carbonization, and other processes.

In the preparation method of the long-cycle and low-expansion silicon-carbon composite material with an internal pore structure, the high-temperature vacuum/pressurized carbonization in step S3 is one or more of vacuum carbonization, high-temperature isostatic pressing, carbonization after pressurization, and other processes.

The carbon coating heat treatment in step S5 is static heat treatment or dynamic heat treatment.

In the static heat treatment, the precursor E is placed in a box furnace, a vacuum furnace or a roller kiln, heated up to 400° C. to 1000° C. at a rate of 1° C./min to 5° C./min in a protective atmosphere, the temperature is kept for 0.5 h to 20 h, and the product is then cooled to room temperature naturally.

In the dynamic heat treatment, the precursor E is placed in a rotary kiln and heated up to 400° C. to 1000° C. at a rate of 1° C./min to 5° C./min in a protective atmosphere and an organic carbon source gas is introduced at a rate of 0 to 20.0 L/min, the temperature is kept for 0.5 h to 20 h, and the product is then cooled to room temperature naturally.

Preferably, the organic carbon source is one or more of methane, ethane, propane, isopropane, butane, isobutane, ethylene, propylene, acetylene, butene, vinyl chloride, vinyl fluoride, vinyl difluoride, ethyl chloride, fluoroethane, difluoroethane, methyl chloride, fluoromethane, difluoromethane, trifluoromethane, methylamine, formaldehyde, benzene, toluene, xylene, styrene, and phenol.

The long-cycle and low-expansion silicon-carbon composite material with an internal pore structure has an initial reversible capacity of not less than 1800 mAh/g, an initial effect of greater than 90%, an expansion rate of less than 40% after 50 cycles, and a capacity retention rate of greater than 90%.

### Comparative Example

1. The silicon source 10 with a particle diameter D50 of 100 nm and absolute ethanol were well mixed and dispersed at a mass ratio of 1:10, and the resulting mixture was subjected to spray granulation to obtain a spray precursor A0.

2. 1000 g of the precursor A0 and 100 g of asphalt were mechanically mixed and fused to obtain a precursor C0; then, the precursor C0 was heated up to 1050° C. in a vacuum furnace at a heating rate of 1° C./min and kept at this temperature for 5 h, and the resulting product was then cooled to room temperature naturally, crushed and sieved to obtain a precursor E0.

3. 1000 g of the obtained precursor E0 was heated up to 1000° C. in a CVD furnace at a heating rate of 5° C./min, high-purity nitrogen was introduced at a rate of 4.0 L/min, methane gas was introduced at a rate of 0.5 L/min for 4 h, and the resulting product was then cooled to room temperature naturally to obtain a silicon-carbon composite material.

### Example 1

1. The silicon source 10 with a particle diameter D50 of 100 nm, 8 μm polyimide resin and absolute ethanol were well mixed and dispersed at a mass ratio of 100:20:1000, and the resulting mixture was subjected to spray granulation to obtain a spray precursor A1.

2. The spray precursor A1 was sintered in a protective nitrogen atmosphere at 1050° C. at a heating rate of 1° C./min and held at this temperature for 5 h to obtain a precursor B1.

3. 1000 g of the precursor B1 and 100 g of asphalt were mechanically mixed and fused to obtain a precursor C1; then, the precursor C1 was heated up to 1050° C. in a vacuum furnace at a heating rate of 1° C./min and held at this temperature for 5 h, and the resulting product was then cooled to room temperature naturally, crushed and sieved to obtain a precursor E1.

4. 1000 g of the obtained precursor E1 was heated up to 1000° C. in a CVD furnace at a heating rate of 5° C./min, high-purity nitrogen was introduced at a rate of 4.0 L/min, methane gas was introduced at a rate of 0.5 L/min for 4 h, and the resulting product was then cooled to room temperature naturally to obtain a silicon-carbon composite material.

### Example 2

1. The silicon source 10 with a particle diameter D50 of 100 nm, 2 μm polyimide resin and absolute ethanol were well mixed and dispersed at a mass ratio of 100:20:1000, and the resulting mixture was subjected to spray granulation to obtain a spray precursor A2.

2. The spray precursor A2 was sintered in a protective nitrogen atmosphere at 1050° C. at a heating rate of 1° C./min and held at this temperature for 5 h to obtain a precursor B2.

3. 1000 g of the precursor B2 and 100 g of asphalt were mechanically mixed and fused to obtain a precursor C2; then, the precursor C2 was heated up to 1050° C. in a vacuum furnace at a heating rate of 1° C./min and held at this temperature for 5 h, and the resulting product was then cooled to room temperature naturally, crushed and sieved to obtain a precursor E2.

4. 1000 g of the obtained precursor E2 was heated up to 1000° C. in a CVD furnace at a heating rate of 5° C./min, high-purity nitrogen was introduced at a rate of 4.0 L/min, methane gas was introduced at a rate of 0.5 L/min for 4 h, and the resulting product was then cooled to room temperature naturally to obtain a silicon-carbon composite material.

### Example 3

1. The silicon source 10 with a particle diameter D50 of 100 nm, 2 μm polyimide resin and absolute ethanol were well mixed and dispersed at a mass ratio of 100:30:1000, and the resulting mixture was subjected to spray granulation to obtain a spray precursor A3.

2. The spray precursor A3 was sintered in a protective nitrogen atmosphere at 900° C. at a heating rate of 1° C./min and held at this temperature for 5 h to obtain a precursor B3.

3. 1000 g of the precursor B3 and 100 g of asphalt were mechanically mixed and fused to obtain a precursor C3; then, the precursor C3 was heated up to 1050° C. in a vacuum furnace at a heating rate of 1° C./min and held at this temperature for 5 h, and the resulting product was then cooled to room temperature naturally, crushed and sieved to obtain a precursor E3.

4. 1000 g of the obtained precursor E3 was heated up to 1000° C. in a CVD furnace at a heating rate of 5° C./min, high-purity nitrogen was introduced at a rate of 4.0 L/min, methane gas was introduced at a rate of 0.5 L/min for 4 h, and the resulting product was then cooled to room temperature naturally to obtain a silicon-carbon composite material.

### Example 4

1. The silicon source 10 with a particle diameter D50 of 100 nm, 2 μm polyvinyl alcohol, and absolute ethanol were well mixed and dispersed at a mass ratio of 100:5:1000, and the resulting mixture was subjected to spray granulation to obtain a spray precursor A4.

2. The spray precursor A4 was sintered in a protective nitrogen atmosphere at 850° C. at a heating rate of 1° C./min and held at this temperature for 5 h to obtain a precursor B4.

3. 1000 g of the precursor B4 and 100 g of asphalt were mechanically mixed and fused to obtain a precursor C4; then, the precursor C4 was heated up to 1050° C. in a vacuum furnace at a heating rate of 1° C./min and held at this temperature for 5 h, and the resulting product was then cooled to room temperature naturally, crushed and sieved to obtain a precursor E4.

4. 1000 g of the obtained precursor E4 was heated up to 1000° C. in a CVD furnace at a heating rate of 5° C./min, high-purity nitrogen was introduced at a rate of 4.0 L/min, methane gas was introduced at a rate of 0.5 L/min for 4 h, and the resulting product was then cooled to room temperature naturally to obtain a silicon-carbon composite material.

Test conditions: the materials prepared in Comparative Example and Examples were taken as anode materials, and respectively mixed with a binder polyvinylidene fluoride (PVDF) and a conductive agent (Super-P) at a mass ratio of 70:15:15. An appropriate amount of N-methylpyrrolidone (NMP) was respectively added as a solvent to the obtained mixtures to prepare slurry. The slurry was applied to copper foils, and the copper foils were then vacuum dried and rolled to obtain anode pole pieces; metal lithium sheets were used as the counter electrodes, 1 mol/L LiPF6 three-component mixed solvent (EC:DMC:EMC=1:1:1 (v/v)) was used as electrolyte, and polypropylene microporous membrane was used as the diaphragm; all these were assembled into CR2032 button batteries in a glove box full of inert gas. The charge and discharge tests for the button batteries were performed by 0.1 C constant current charge and discharge on the LANHE battery test system provided by Wuhan Landian Electronics Co., Ltd., at room temperature under a charge and discharge voltage between 0.005V and 1.5V.

The volume expansion rates of the materials were tested and calculated in the following way. The cycle performance of a composite material with a capacity of 500 mAh/g prepared by compounding the prepared silicon-carbon composite material and graphite was tested. Expansion rate=(pole piece thickness after 50 cycles-pole piece thickness before the cycle)/(pole piece thickness before the cycle-copper foil thickness)*100%.

The initial cycle test and cycle expansion test were performed on the examples and comparative examples respectively, as shown in Table 1 and Table 2.

TABLE 1

| | Initial specific | Initial specific | Initial |
|---|---|---|---|
| | charge capacity | discharge capacity | Coulombic |
| | mAh/g | mAh/g | efficiency % |
| Comparative | 2176.8 | 1925.4 | 88.45 |
| Example | | | |
| Example 1 | 2061.8 | 1875.2 | 90.95 |
| Example 2 | 1987.4 | 1800.1 | 90.58 |
| Example 3 | 2001.6 | 1812.6 | 90.56 |
| Example 4 | 2028.2 | 1831.6 | 90.31 |

TABLE 2

| | Initial discharge | | |
|---|---|---|---|
| | specific capacity | 50-cycle | 50-cycle capacity |
| | mAh/g | expansion rate % | retention rate |
| Comparative | 500.1 | 57.3 | 53.2 |
| Example | | | |
| Example 1 | 500.5 | 39.5 | 87.6 |
| Example 2 | 500.4 | 38.6 | 90.3 |
| Example 3 | 500.6 | 38.3 | 91.4 |
| Example 4 | 500.6 | 38.5 | 90.5 |

The above-described embodiments only show several implementations of the invention, which are more specific and detailed, but not to be construed as limiting the scope of the invention. It should be noted that those of ordinary skill in the art may further make variations and improvements without departing from the conception of the invention, and these all fall within the protection scope of the invention. Therefore, the patent protection scope of the present disclosure should be subject to the appended claims.

What is claimed is:

1. A silicon-carbon composite material with an internal pore structure, consisting of a silicon source, a closed pore, a filling layer and a carbon coating layer, wherein the closed pore is a large closed pore or composed of a plurality of small closed pores, and the filling layer is a carbon filling layer filled among particles of the silicon source, and the carbon coating layer encloses the silicon source, the closed pore and the filling layer therein.

2. The silicon-carbon composite material with an internal pore structure according to claim 1, wherein an outer surface of the closed pore comprises a carbon layer, a size of the large closed pore is larger than 50 nm but less than or equal to 8 μm, and a size of the small closed pore is larger than 10 nm but less than or equal to 50 nm.

3. The silicon-carbon composite material with an internal pore structure according to claim 1, wherein the silicon source is any one or more of polycrystalline nano-silicon and amorphous nano-silicon.

4. The silicon-carbon composite material with an internal pore structure according to claim 1, wherein when the silicon source is polycrystalline nano-silicon, a crystal size of the polycrystalline nano-silicon is 1 nm to 40 nm.

5. The silicon-carbon composite material with an internal pore structure according to claim 1, wherein the silicon source is SiOx, where X is between 0 and 0.8; a particle diameter D50 of the silicon source is less than 200 nm.

6. A preparation method of a silicon-carbon composite material with an internal pore structure, comprising the following steps:
S0, mixing and dispersing a silicon source, a dispersant, and a pore-former in a solvent evenly, and performing spray drying treatment to obtain a precursor A;
S1, carbonizing the precursor A to obtain a precursor B;
S2, mechanically mixing and fusing the precursor B and an organic carbon source to obtain a precursor C;
S3, carrying out high-temperature, vacuum or pressurized carbonization on the precursor C to obtain a precursor D;
S4, crushing and sieving the precursor D to obtain a precursor E; and
S5, carrying out carbon coating heat treatment on the precursor E to obtain the silicon-carbon composite material.

7. The preparation method of silicon-carbon composite material with an internal pore structure according to claim 6, wherein the pore-former in step S0 is an organic substance insoluble or slightly soluble in the dispersant.

8. The preparation method of a silicon-carbon composite material with an internal pore structure according to claim 7, wherein the pore-former comprises one or more of sucrose, glucose, citric acid, phenolic resin, epoxy resin, polyimide resin, pitch, polyvinyl alcohol, polypyrrole, polypyrrolidone, polyaniline, polyacrylonitrile, polydopamine, polyethylene, polypropylene, polyamide, polystyrene, polymethyl methacrylate, and polyvinyl chloride.

9. The preparation method of a silicon-carbon composite material with an internal pore structure according to claim 6, wherein, in step S0, a ratio of the pore-former to the silicon source is 1% to 80%.

10. An application of a silicon-carbon composite material with an internal pore structure, wherein the silicon-carbon composite material with an internal pore structure prepared by the preparation method according to claim 6 is applied to lithium-ion batteries.
